(19) United States
(12) Patent Application Publication
(10) Pub. No.: US 2025/0150919 A1
(43) Pub. Date: May 8, 2025

(54) METHOD AND DEVICE FOR ENHANCING ROAMING PERFORMANCE

(71) Applicant: MEDIATEK INC., Hsinchu City (TW)

(72) Inventors: Chun-Ting WU, Hsinchu City (TW); Yu-Shu CHANG, Hsinchu City (TW); Ray-Kuo LIN, Hsinchu City (TW)

(21) Appl. No.: 18/938,547

(22) Filed: Nov. 6, 2024

Related U.S. Application Data
(60) Provisional application No. 63/596,632, filed on Nov. 7, 2023.

(51) Int. Cl. H04W 36/18; H04W 36/02; H04W 36/36; H04W 52/02; H04W 84/12

(52) U.S. Cl. CPC H04W 36/18; H04W 36/023; H04W 36/362; H04W 52/0274; H04W 84/12

(57) ABSTRACT

A method for enhancing roaming performance is provided. The method is implemented by a station MLD and comprises: communicating with a current AP through at least two links, wherein the at least two links comprise a first link and a second link; disabling the second link connected to the current AP; establishing an association with a target AP through a new second link; transmitting a message to the target AP through the new second link to notify a network node that the STA is camping on a cell served by the target AP and to disable the new second link connected to the target AP; retrieving buffered packets from the current AP through the first link for a time duration; disconnecting from the current AP after the time duration; and enabling the new first link and the new second link to retrieve packets from the target AP.

### CROSS REFERENCE TO RELATED APPLICATIONS

This application claims the benefit of U.S. Provisional Application No. 63/596,632, entitled “Enhanced MLD Roaming for STA”, filed on Nov. 7, 2023, the entirety of which is incorporated by reference herein.

### BACKGROUND OF THE INVENTION

### Field of the Invention

The present disclosure generally relates to the field of wireless communication technology. More specifically, aspects of the present disclosure relate to a method and a device for enhancing roaming performance.

### Description of the Related Art

Wireless local area network (WLAN) roaming, or Wi-Fi roaming, refers to the process of a wireless terminal or a station (STA) moving from one access point (AP) to another AP. During WLAN roaming or Wi-Fi roaming, the STA can move freely in the same Wi-Fi network comprising many APs to achieve uninterrupted service.

When an STA roams from a current AP to a target AP, the STA may first disconnect from the current AP. Before the connection with the target AP is established, the current AP and the STA cannot transmit data to each other, and buffered data in the current AP may cause packet loss. In addition, the transition time for the STA to switch from the current AP to the target AP may affect the duration of service interruption.

Institute of Electrical and Electronics Engineers (IEEE) 802.11be, also referred to as Wi-Fi 7, introduces a concept of a Multi-Link Device (MLD) that enables an STA to simultaneously be associated with multiple RF links on an AP. Roaming of multi-link devices is expected to achieve uninterrupted data transmission. However, how to achieve roaming of multi-link devices under IEEE 802.11be, reduce the interruption time of data transmission during roaming, or ensure uninterrupted data transmission during roaming has not yet been solved since a non-AP MLD connecting to two AP MLDs is not allowed.

Therefore, there is a need for a method and a device for enhancing roaming performance to solve these problems.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and a device for enhancing roaming performance to achieve uninterrupted data transmission during roaming.

In an exemplary embodiment, a method for enhancing roaming performance is provided. The method is implemented by a station (STA) multi-link device (MLD). The method comprises communicating with a current AP through at least two links, wherein the at least two links comprise a first link and a second link. The method comprises disabling the second link connected to the current AP. The method comprises establishing an association with a target AP through a new second link, wherein the association comprises a new first link and the new second link. The method comprises transmitting a message to the target AP through the new second link to notify a network node that the STA is camping on a cell served by the target AP and to disable the new second link connected to the target AP. The method comprises retrieving buffered packets from the current AP through the first link for a time duration. The method comprises disconnecting from the current AP after the time duration; and enabling the new first link and the new second link associated to the target AP to retrieve packets from the target AP, wherein the first link and the new first link correspond to the same radio, the second link and the new second link correspond to the same radio, and the new first link and the new second link correspond to different radios.

In some embodiments, the step of disabling the second link connected to the current AP further comprises: transmitting a QOS Null frame with PS_mode=1 to the current AP through the second link for disabling the second link connected to the current AP.

In some embodiments, the new first link is set as a power saving mode by default after the association is established.

In some embodiments, the step of enabling the new first link and the new second link associated to the target AP further comprises: enabling the new first link by transmitting a first QoS Null frame with PS_mode=0 to the target AP through the new first link; and enabling the new second link by transmitting a second QoS Null frame with PS_mode=0 to the target AP through the new second link.

In some embodiments, the method further comprises stopping transmitting uplink (UL) packet of the STA MLD to the current AP through the first link after disabling the second link connected to the current AP or after establishing the association with the target AP through the new second link.

In some embodiments, the first message is transmitted after the current AP flushes buffered UL packet of the STA MLD to the network node.

In some embodiments, the message is a first broadcast message for triggering the target AP to transmit a second broadcast message to the network node to update a downlink (DL) path of the network node from the current AP to the target AP; and the first broadcast message is a QoS Null frame with PS_mode=1 for disabling the new second link connected to the target AP.

In some embodiments, the step of enabling the new first link and the new second link associated to the target AP to retrieve packets from the target AP comprises: enabling the new first link and the new second link associated to the target AP to retrieve buffered packets from the target AP, wherein the buffered packets are sent by the network node to the target AP after receiving the second broadcast message.

In an exemplary embodiment, a method for enhancing roaming performance is provided. The method is implemented by a station (STA). The method comprises communicating with a current AP through a first link. The method comprises disabling the first link connected to the current AP. The method comprises establishing an association with a target AP through a new first link. The method comprises transmitting a message to the target AP through the new first link to notify a network node that the STA is camping on a cell served by the target AP and to disable the new first link connected to the target AP. The method comprises enabling the first link to retrieve buffered packets from the current AP through the first link for a time duration. The method comprises disconnecting from the current AP after the time duration. The method comprises enabling the new first link connected to the target AP to retrieve packets from the target AP. The method comprises the first link and the new first link correspond to the same radio.

In some embodiments, the step of disabling the first link connected to the current AP further comprises: transmitting a QoS Null frame with PS_mode=1 to the current AP through the first link for disabling the first link connected to the current AP.

In some embodiments, the method further comprises stopping transmitting UL packets to the current AP through the first link after disabling the first link connected to the current AP.

In some embodiments, the message is a first broadcast message for triggering the target AP to transmit a second broadcast message to the network node to update a downlink (DL) path of the network node from the current AP to the target AP; and the first broadcast message is a QoS Null frame with PS_mode=1 for disabling the new first link connected to the target AP.

In some embodiments, the step of enabling the new first link associated to the target AP to retrieve packets from the target AP comprising: enabling the new first link associated to the target AP to retrieve buffered packets from the target AP, wherein the buffered packets are sent by the network node to the target AP after receiving the second broadcast message.

In some embodiments, the step of enabling the first link to retrieve packets from the current AP further comprises: transmitting a QoS Null frame with PS_mode=1 through the first link for enabling the first link connected to the current AP.

In an exemplary embodiment, a device for enhancing roaming performance is provided. The device comprises a processor, a memory coupled to the processor and for storing data and a plurality of radios operable to perform wireless transmission. The processor is operable to communicate with a current AP through at least two links, wherein the at least two links comprise a first link and a second link. The processor is operable to disable the second link connected to the current AP. The processor is operable to establish an association with a target AP through a new second link; wherein the association comprises a new first link and the new second link. The processor is operable to transmit a message to the target AP through the new second link to notify a network node that the STA is camping on a cell served by the target AP and to disable the new second link connected to the target AP. The processor is operable to retrieve buffered packets from the current AP through the first link for a time duration. The processor is operable to disconnect from the current AP after the time duration. The processor is operable to enable the new first link and the new second link associated to the target AP to retrieve packets from the target AP. The first link and the new first link use the same radio, the second link and the new second link use the same radio, and the new first link and the new second link use different radios.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of an architecture of a wireless communication system according to an embodiment of the disclosure.

FIG. 2 is example Media Access Control (MAC) protocol stacks of an AP MLD 210 and an STA MLD 220 according to embodiments of the present disclosure.

FIGS. 3A˜3E show a process for enhancing roaming performance implemented by an STA MLD according to embodiments of the present disclosure.

FIG. 4 is a schematic flowchart illustrating the time duration T according to an embodiment of the disclosure.

FIG. 5 is a flow chart depicting an exemplary sequence of computer implemented steps of a method for enhancing roaming performance according to an embodiment of the disclosure.

FIGS. 6A˜6E show a process for enhancing roaming performance implemented by an STA according to embodiments of the present disclosure.

FIG. 7 is a flow diagram depicting an exemplary sequence of computer-implemented steps for a method for enhancing roaming performance in accordance with embodiments of the disclosure.

FIG. 8 depicts an exemplary wireless device upon which embodiments of the present disclosure can be implemented.

### DETAILED DESCRIPTION OF THE INVENTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

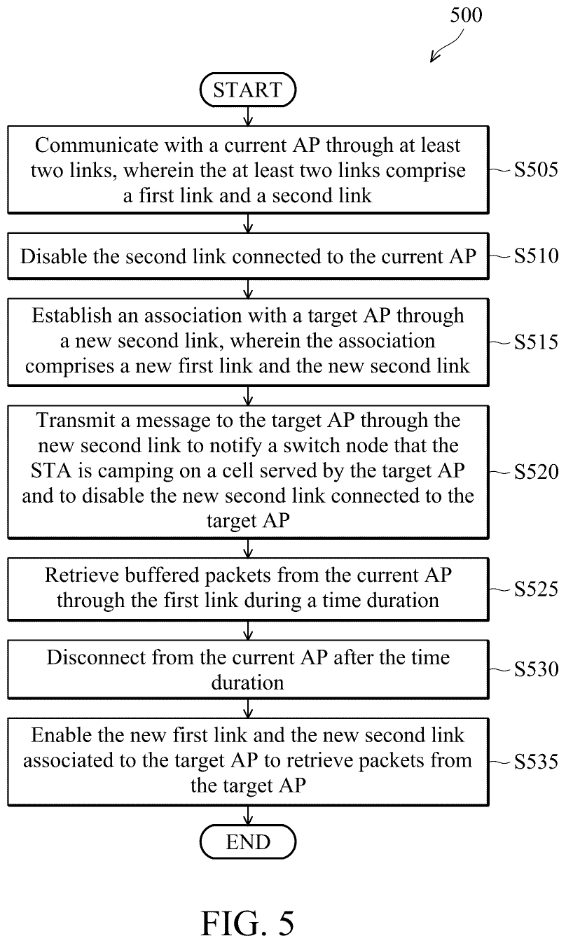

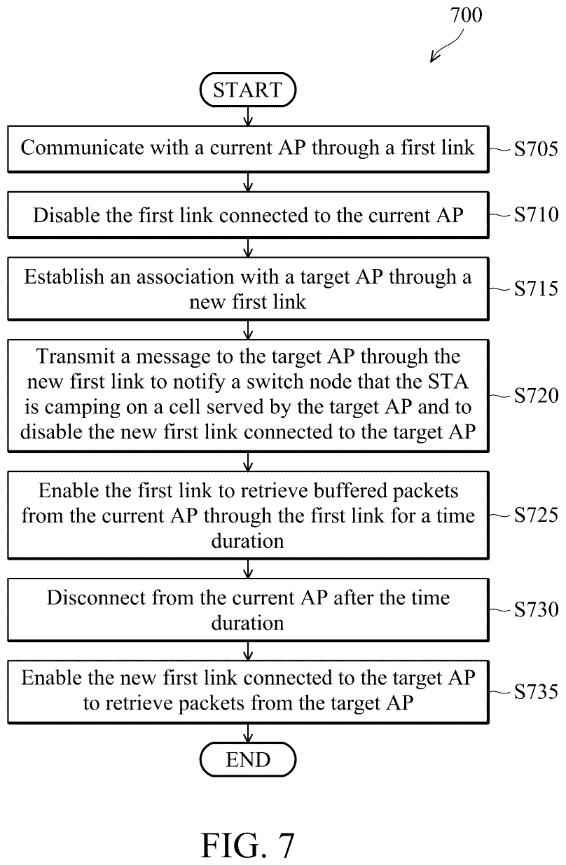

Portions of the detailed description that follow are presented and discussed in terms of a method. Although steps and sequencing thereof are disclosed in a figure herein (e.g., FIGS. 5 and 7) describing the operations of this method, such steps and sequencing are exemplary. Embodiments are well suited to performing various other steps or variations of the steps recited in the flowchart of the figure herein, and in a sequence other than that depicted and described herein.

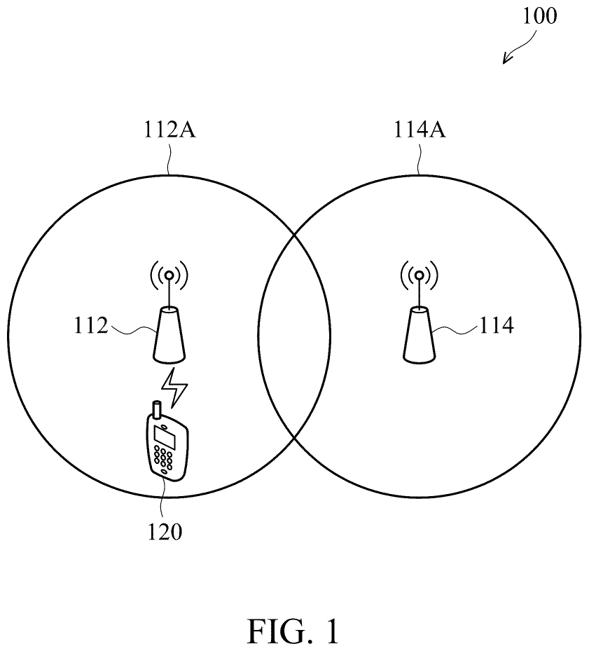

FIG. 1 is a schematic diagram of architecture of a wireless communication system 100 according to an embodiment of the disclosure. FIG. 1 uses a wireless local area network as an example. The wireless communication system 100 includes one or more AP multi-link devices (for example, an AP multi-link device 112 and an AP multi-link device 114 in FIG. 1) and an STA multi-link device 120.

The communication area (or coverage area) 112A or 114A of the AP multi-link device 112 or 114 may be referred to as a “cell.” The STA multi-link device 120 may be in a cell or a coverage area 112A of the AP multi-link device 112.

The AP multi-link device is a multi-link device that provides a service for the STA multi-link device, and the STA multi-link device may communicate with the AP multi-link device by using a plurality of links, to improve a throughput. A quantity of AP multi-link devices and a quantity of STA multi-link devices in FIG. 1 are merely an example.

For example, a multi-link device (for example, any one of the AP multi-link device 112, the AP multi-link device 114, and the STA multi-link device 120 in FIG. 1) is an apparatus having a wireless communication function. The apparatus may be an entire device, or may be a chip, a processing system, or the like installed in an entire device. A device in which these chips or processing systems are installed may be controlled by these chips or processing systems, to implement the method and a function in embodiments of the disclosure. For example, the AP multi-link device in embodiments of the disclosure is an apparatus that provides a service for the STA multi-link device, and may support the 802.11 series protocols.

The STA multi-link device in embodiments of the disclosure has a wireless transceiver function, may support the 802.11 series protocols, and may communicate with the AP multi-link device or another STA multi-link device. For example, the STA multi-link device is any user communication device that allows a user to communicate with an AP. For example, the STA multi-link device may be user equipment that can be connected to a network, such as a tablet computer, a desktop computer, a laptop computer, a notebook computer, an ultra-mobile personal computer (Ultra-mobile personal computer, UMPC), a handheld computer, a netbook, a personal digital assistant (personal digital assistant, PDA), or a mobile phone, may be an internet of things node in the internet of things, or may be a vehicle-mounted communication apparatus in the internet of vehicles. The STA multi-link device may alternatively be a chip and a processing system in the foregoing terminals. Certainly, the STA multi-link device may alternatively be chips and processing systems in the various forms of devices, to implement the method and the function in embodiments of this application. The 802.11 protocol may be a protocol that supports 802.11be or is compatible with 802.11be.

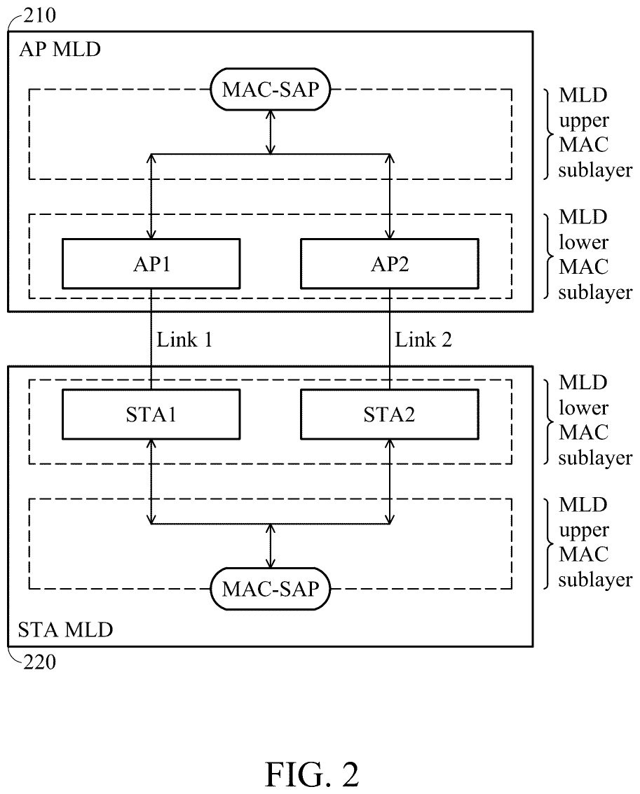

FIG. 2 is example Media Access Control (MAC) protocol stacks of an AP MLD 210 and an STA MLD 220 according to embodiments of the present disclosure.

As shown in FIG. 2, a MLD lower MAC sublayer in AP MLD comprises AP 1 and AP 2 independent of each other. In a UL direction, AP 1 and AP 2 in the MLD lower MAC sublayer transfer information or data to a MLD upper MAC sublayer. The MLD upper MAC sublayer transmits the information or data of AP 1 and AP 2 through MAC SAP (Service Access Point) to an upper layer. In a DL direction, the MLD upper MAC sublayer receives information or data from the upper layer through MAC SAP and transmits the information or data to AP 1 and AP 2.

Similarly, a MLD lower MAC sublayer in STA MLD comprises STA 1 and STA 2 independent of each other. In a UL direction, STA 1 and STA 2 in the MLD lower MAC sublayer transfer information or data to a MLD upper MAC sublayer. The MLD upper MAC sublayer transmits the information or data of STA 1 and STA 2 through MAC SAP to an upper layer. In a DL direction, the MLD upper MAC sublayer receives the information or data from the upper layer through MAC SAP and transmits the information or data to STA 1 and STA 2.

The AP MLD 210 and the STA MLD 220 may perform transmissions over multiple links (Link 1 and Link 2). STA1 may connect to AP1. STA2 may connect to AP2. The connection between STA1 and AP 1 is link1. The connection between STA2 and AP 2 is link2. The Link 1 uses one radio. The Link 2 uses another radio. The link 1 and link 2 use different radios. In addition, the AP MLD 210 and the STA MLD 220 may be capable of operating on two or more links simultaneously. The links may be at different frequency bands, such as 2.4 GHz, 5 GHz and 6 GHz bands reserved for unlicensed operation.

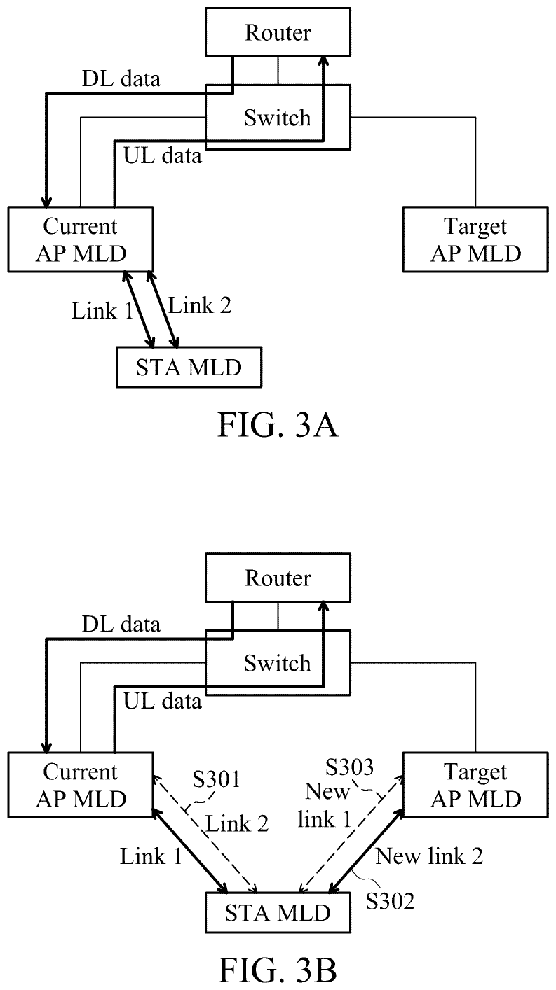

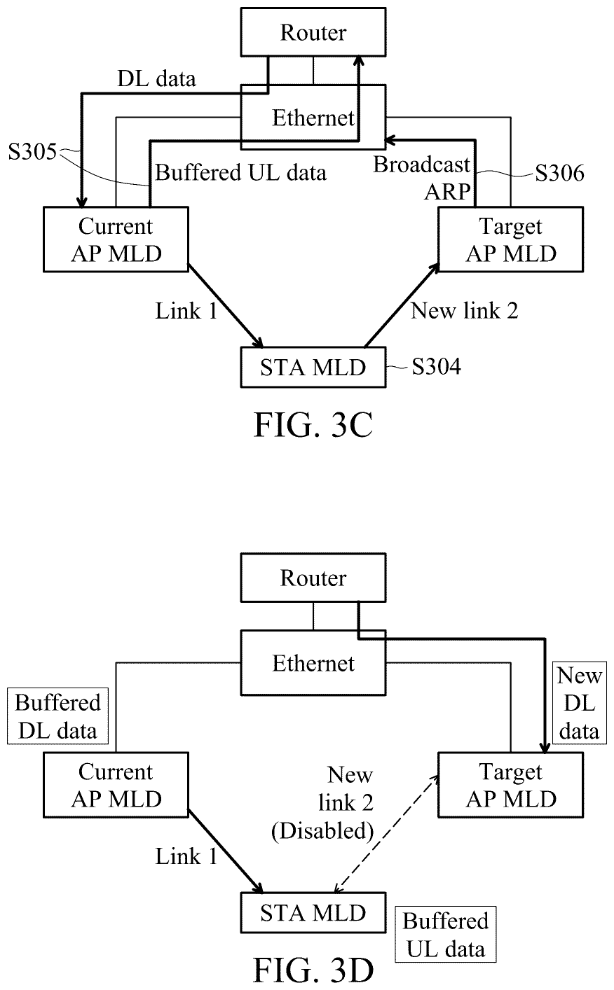

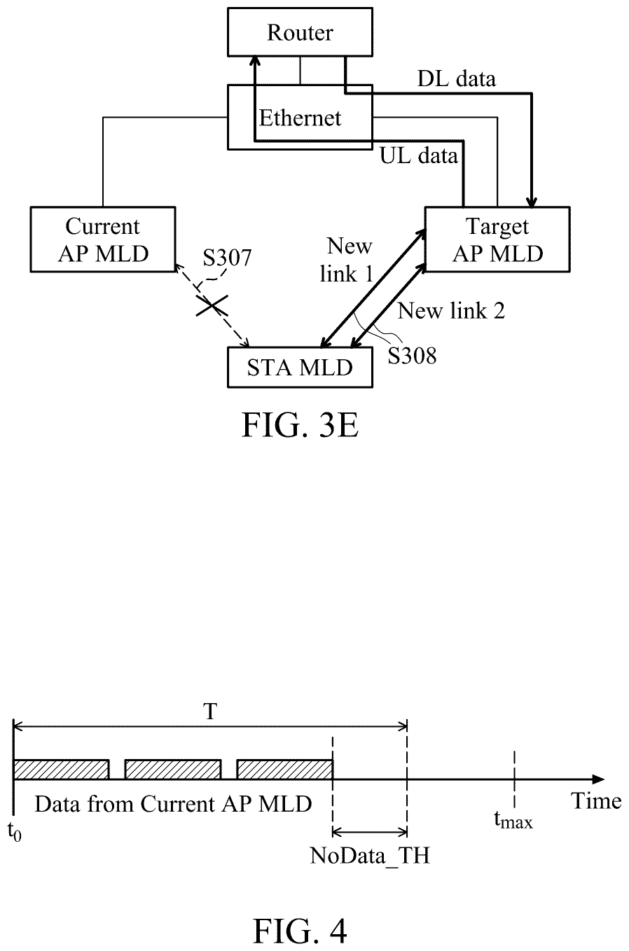

FIGS. 3A˜3E show a process for enhancing roaming performance implemented by an STA MLD according to embodiments of the present disclosure.

In FIG. 3A, the STA MLD is connected to a current AP MLD, and communicates with the current AP MLD through a link 1 and a link 2. The router may transmit downlink (DL) packet of the STA MLD to the current AP MLD through a switch node, and receive uplink (UL) packet of the STA MLD from the current AP MLD through the switch node, wherein the DL packet includes a Media Access Control (MAC) destination address (DA), which is an address of the STA MLD, and an MAC source address (SA), which is an address of the router, and the UL packet includes an MAC DA, which is an address of the router, and an MAC SA, which is an address of the STA MLD. The STA MLD may receive the DL packet from the current AP MLD and transmit the UL packet to the current AP MLD through the link 1 and the link 2. The link 1 and the link 2 may be at different frequency bands. The link 1 may be a 2G band link. The link 2 may be a 5G band link.

In FIG. 3B, the STA MLD transmits a QoS Null frame with PS_mode=1 to the current AP MLD through the link 2 for disabling the link 2 connected to the current AP MLD in step S301. Then, in step S302, the STA MLD establishes an association with a target AP MLD through a new link2. The association comprises a new link 1 and the new link 2. Specifically, in some embodiments, the STA MLD may transmit a message (e.g. an association request) to AP through the new link 2 for notifying the target AP MLD that the STA MLD has the new link 1 and the new link 2 available for communication with the target AP MLD. Because the new link 2 is a setup link for establishing the association, the new link 2 is awake. Because the new link 1 is a non-setup link, the new link 1 is set in a power saving mode by default after the new link 1 is established. In other words, the STA MLD disables the new link 1 after establishing the new link 1.

In FIG. 3C, the STA MLD stops transmitting the UL packet through the link 1 in step S304. In other words, the STA MLD may only receive the DL packet from the current AP MLD through the link 1. In step S305, the current AP MLD flushes the buffered UL packet of the STA MLD to the switch node and buffers the DL packet of the STA MLD from the switch node. In step S306, the STA MLD transmits a first message to the target AP MLD through the new link 2 for triggering the target AP to transmit a second message to the switch node to notify the switch node that the STA MLD is camping on a cell served by the target AP MLD. The first message may carry an indication for disabling the new link 2 connected to the target AP MLD. The first message and the second message may be broadcast Address Resolution Protocol (ARP) messages. The first broadcast ARP message is transmitted by the STA MLD. In the first broadcast ARP message, a TA address is the STA MLD address, a RA address is the target AP MLD address, and DA is FF:FF:FF:FF:FF:FF. The target AP MLD transmits a second broadcast ARP message after receiving first broadcast ARP message. In the second broadcast ARP message, a TA address is the STA MLD address and DA is FF:FF:FF:FF:FF:FF. The switch node receives the second broadcast ARP message. The switch node can learn that the STA MLD is camping on a cell served by the target AP MLD, and DL packet of the STA MLD should be transferred to the target AP MLD. The first ARP message may be a QoS Null frame with PS_mode=1 for disabling the new link 2 connected to the target AP MLD. In some embodiments, the first broadcast ARP message is an 802.11 unicast packet, and the second broadcast ARP message is an 802.11 unicast packet.

The STA MLD may estimate the amount of UL packets of the STA MLD stored in the current AP MLD. The STA MLD may estimate a period based on the amount of UL packets of the STA MLD stored in the current AP MLD and wait at least the estimated period before transmitting the first broadcast ARP. Because the switch node determines the DA of DL packets to the STA MLD based on the SA of a last received UL packet of the STA MLD, so the STA MLD need wait the estimated time period before transmitting the first ARP message to the target AP MLD, so that the current AP MLD completes a transmission of the UL packets stored in the current AP MLD and the second ARP message from the target AP MLD is the last received UL packet of the STA MLD. With this arrangement, the switch node can learn DL packet of the STA MLD should be transferred to the target AP MLD.

In FIG. 3D, the STA MLD retrieves the buffered DL packets from the current AP MLD through the link 1.

Before receiving the second broadcast ARP from the target AP MLD, the switch node transmits DL packets of the STA MLD to the current AP MLD. After receiving the second broadcast ARP from the target AP MLD, the switch node transmits DL packets of the STA MLD to the target AP MLD. The current AP MLD buffered old DL packets of the STA MLD and the target AP MLD buffered new DL packets of the STA MLD. Because the STA receives old DL packets from current AP MLD through the link 1 and suspends the new link2 with the target AP MLD, the STA MLD does not receive old DL packets from the current AP MLD and new DL packets from the target AP MLD simultaneously to avoid misordering received packets.

In FIG. 3E, the STA MLD disconnects from the current AP MLD after the time duration in step S307. Specifically, the STA MLD may wait for a time duration T to retrieve the buffered DL packets from the current AP MLD since the STA MLD does not know the buffer status of the current AP MLD. FIG. 4 is a schematic flowchart illustrating the time duration T according to an embodiment of the disclosure. As shown in FIG. 4, to is the time for the STA MLD to transmit the first ARP message to the target AP, and a time duration t_{NoData} is the last time when the buffered DL packet is received from the current AP MLD plus a threshold NoData_TH. In addition, a maximum waiting time tₘₐₓ can be preset through experiences or experiments. When the time duration t_{NoData} is less than tₘₐₓ, the time duration T equals to the time duration t_{NoData} and the STA MLD disconnects from the current AP MLD after the time duration t_{NoData}; otherwise, the time duration T equals to tₘₐₓ and the STA waits for the maximum waiting time tₘₐₓ before disconnecting from the current AP MLD.

In step S308, the STA MLD transmits a QoS Null frame with PS_mode=0 to the target AP MLD through the new link 1 and the new link 2, respectively, for enabling the new link 1 and the new link 2 connected to the target AP MLD. Therefore, the STA MLD may transmit UL packet to and receive DL packet from the target AP MLD through the new link 1 and the new link 2. In other words, the process may reduce latency and enhance reliability when the STA MLD roams to the target AP MLD.

FIG. 5 is a flow chart 500 depicting an exemplary sequence of computer implemented steps of a method for enhancing roaming performance according to an embodiment of the disclosure, wherein the method is implemented by a station (STA) or the STA MLD in FIGS. 3A˜3E.

In step S505, the STA communicates with a current AP through at least two links, wherein the at least two links comprise a first link and a second link.

Then, in step S510, the STA disables the second link connected to the current AP.

Specifically, the STA may transmit a QoS Null frame with PS_mode=1 to the current AP through the second link for disabling the second link connected to the current AP.

In step S515, the STA establishes an association with a target AP through a new second link, wherein the association comprises a new first link and the new second link.

In some embodiments, the STA stops transmitting UL packet of the STA MLD through the first link after disabling the second link connected to the current AP in step S510 or after establishing the association with the target AP through the new second link in step S515.

In step S520, the STA transmits a message to the target AP through the new second link to notify a switch node that the STA is camping on a cell served by the target AP and to disable the new second link connected to the target AP.

In one embodiment, the message transmitted by the STA is one message. In some embodiments, the message is a first broadcast Address Resolution Protocol (ARP) message for triggering the target AP to transmit a second broadcast ARP message to the switch node to update the DL path of the switch node from the current AP MLD to the target AP MLD in the switch node. The second broadcast ARP message is used for the switch node to learn DL packet of the STA MLD should be transferred to the target AP MLD. In another embodiment, the first broadcast ARP message is a QoS Null frame with PS_mode=1 for disabling the new second link connected to the target AP, and the first broadcast ARP message is an 802.11 unicast packet, and the second broadcast ARP message is an 802.3 packet.

In one embodiment, the message transmitted by the STA comprises two messages, wherein one message in the two messages is used for triggering the target AP to transmit the second broadcast ARP message to the switch node to update a DL path of the switch node from the current AP to the target AP in the switch node, and the other message in the two messages is used for disabling the new second link.

Next, in step S525, the STA retrieves buffered packets from the current AP through the first link during a time duration.

In step S530, the STA disconnects from the current AP after the time duration.

In step S510, the STA disables the second link connected to the current AP. However, the current AP does not delete an association of the second link and maintains the association of the second link until the STA disconnects from the current AP.

In step S535, the STA enables the new first link and the new second link associated to the target AP to retrieve packets from the target AP.

Specifically, the STA may transmit a first QoS Null frame with PS_mode=0 to the target AP through the new first link for enabling the new first link associated to the target AP, and transmit a second QoS Null frame with PS_mode=0 to the target AP through the new second link for enabling the new second link associated to the target AP.

The first link and the new first link correspond to the same radio, the second link and the new second link correspond to the same radio, and the new first link and the new second link correspond to different radios. Specifically, the first link and the new first link use the same radio, the second link and the new second link use the same radio, and the new first link and the new second link use different radios.

Referring to FIG. 1, the first link and the new first link are created by STA 1 in the STA MLD, and the first link and the new first link use a first radio. The second link and the new second link are created by STA 2 in the STA MLD, and the second link and the new second link use a second radio.

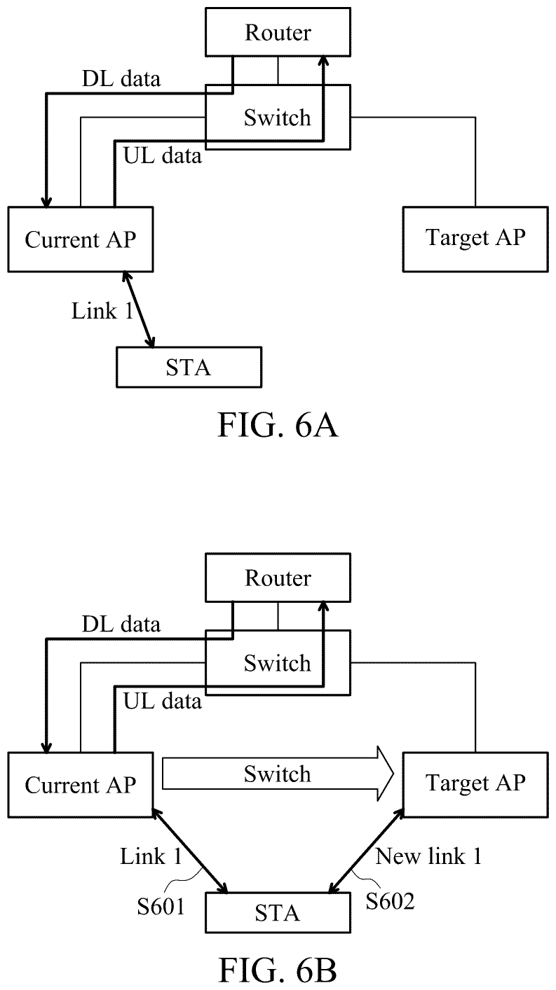

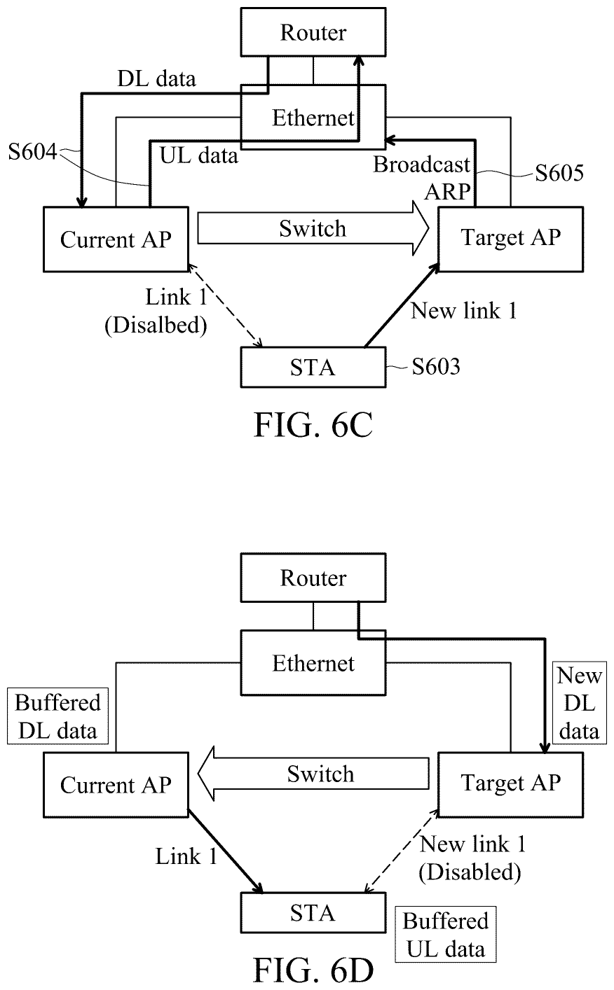

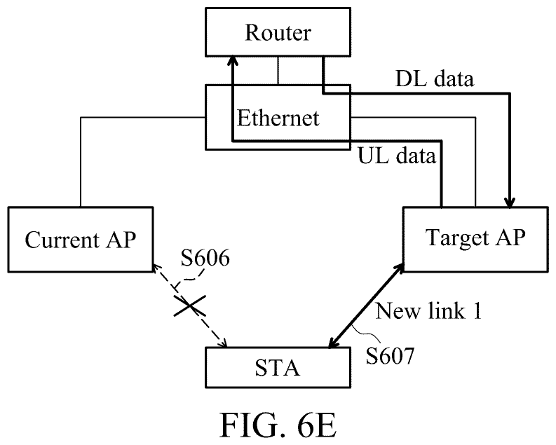

FIGS. 3A˜3E and FIG. 5 uses the STA that is an MLD as an example for explanation. FIGS. 6A˜6E and FIG. 7 illustrate using the STA that is not an MLD as an example. It should be noted that the STA that is not an MLD may only communicate with the current AP or the target AP through a single link, and the STA is suitable for environments such as Wi-Fi 5/6. The STA may include an eMLSR (enhanced Multi-Link-Single-Radio) STA.

FIGS. 6A˜6E show a process for enhancing roaming performance implemented by an STA according to embodiments of the present disclosure.

In FIG. 6A, the STA is connected to a current AP, and communicates with the current AP through a link 1. The router may transmit downlink (DL) packet to the current AP through a switch node, and receive uplink (UL) packet from the current AP through the switch node, wherein the DL packet includes a Media Access Control (MAC) destination address (DA), which is an address of the STA, and an MAC source address (SA), which is an address of the router, and the UL packet includes an MAC DA, which is the address of the router, and an MAC SA, which is the address of the STA. The STA may receive the DL packet from the current AP and transmit the UL packet to the current AP through the link 1.

In FIG. 6B, the STA transmits a QoS Null frame with PS_mode=1 to the current AP through the link 1 for disabling the link 1 connected to the current AP in step S601. Then, in step S602, the STA establishes an association with a target AP through a new link. In other words, the STA switches from the link 1 to the new link 1. The first link and the new first link share the same radio.

In FIG. 6C, the STA stops transmitting the UL packet of the STA through the link 1 in step S603. In step S604, the current AP flushes the buffered UL packet to the switch node and buffers the DL packet from the switch node. In step S605, the STA transmits a first message to the target AP through the new link 1 and the target AP transmits a second message to the switch node for notifying the switch node that the STA is camping on a cell served by the target AP. The first message may carry an indication for disabling the new link 1 connected to the target AP. The first message and the second message are broadcast Address Resolution Protocol (ARP) messages. The first broadcast ARP message is transmitted by the STA. In the first broadcast ARP message, a TA is the STA address, a RA is the target AP address, and DA is FF:FF:FF:FF:FF:FF. The target AP transmits a second broadcast ARP message after receiving first broadcast ARP message. In the second broadcast ARP message, a TA is the target AP address and DA is FF:FF:FF:FF:FF:FF. The switch node receives the second broadcast ARP message. The switch node can learn that the STA is camping on a cell served by the target AP, so DL packet of the STA should be transferred to the target AP MLD. So, the first broadcast ARP message is used for triggering the target AP to transmit the second broadcast message to the switch node to update a DL path of the switch node from the current AP to the target AP in the switch node. The first broadcast ARP message is a QoS Null frame with PS_mode=1 for disabling the new link 1 connected to the target AP. In some embodiments, the first broadcast ARP message is an 802.11 unicast packet, and the second broadcast ARP message is a 802.3 packet.

In FIG. 6D, the STA enables the link 1 and retrieves the buffered DL packets from the current AP through the link 1. In one embodiment, the STA transmits a QoS Null frame with PS_mode=1 through the link 1 for enabling the link 1 connected to the current AP. Meanwhile, the target AP buffers new DL packets from the switch node and the STA buffers UL packets since the new link 1 is disabled.

In FIG. 6E, the STA disconnects from the current AP after the time duration in step S606. Specifically, the STA may wait for a time duration T to retrieve the buffered DL packets from the current AP since the STA does not know the buffer status of the current AP. The time duration T is the same as the time duration T in FIG. 4, so details related to the time duration T will be omitted.

In step S607, the STA transmits a QoS Null frame with PS_mode=0 to the target AP through the new link 1 for enabling the new link 1 connected to the target AP. Therefore, the STA may transmit UL packets to and receive DL packets from the target AP through the new link 1. In other words, the process may reduce latency and enhance reliability when the STA roams to the target AP.

FIG. 7 is a flow diagram 700 depicting an exemplary sequence of computer-implemented steps for a method for enhancing roaming performance in accordance with embodiments of the disclosure, wherein the method is implemented by a station (STA) or the STA in FIGS. 6A˜6E.

In step S705, the STA communicates with a current AP through a first link.

In step S710, the STA disables the first link connected to the current AP.

Specifically, the STA transmits a QoS Null frame with PS_mode=1 to the current AP through the first link for disabling the first link connected to the current AP. In some embodiments, the STA stops transmitting UL packet to the current AP after disabling the first link connected to the current AP in step S710.

In step S715, the STA establishes an association with a target AP through a new first link.

In step S720, the STA transmits a message to the target AP through the new first link to notify a switch node that the STA is camping on a cell served by the target AP and to disable the new first link connected to the target AP.

In one embodiment, the message is a first broadcast Address Resolution Protocol (ARP) message for triggering the target AP to transmit the second broadcast ARP message to the switch node to update a DL path of the switch node from the current AP to the target AP in the switch node. In some embodiments, the first broadcast ARP message is a QoS Null frame with PS_mode=1 for disabling the new first link connected to the target AP, and the first broadcast ARP message is a 802.11 unicast packet and the second broadcast ARP message is a 802.3 packet.

In one embodiment, the message transmitted by the STA comprises two messages, wherein one message in the two messages is used for triggering the target AP to transmit the second broadcast ARP message to the switch node to update a DL path of the switch node from the current AP to the target AP in the switch node, and the other message in the two messages is used for disabling the new first link.

In step S725, the STA enables the first link to retrieve buffered packets from the current AP through the first link for a time duration.

Specifically, the STA transmits a QoS Null frame with PS_mode=1 through the first link for enabling the first link connected to the current AP.

In step S730, the STA disconnects from the current AP after the time duration.

In step S735, the STA enables the new first link connected to the target AP to retrieve packets from the target AP.

In this step, the STA may enable the new first link associated to the target AP to retrieve buffered packets from the target AP, wherein the buffered packets are sent by the switch node to the target AP after receiving the second broadcast ARP message. Specifically, the STA transmits a QoS Null frame with PS_mode=1 through the new first link for enabling the new first link connected to the target AP.

In some embodiments, the first link and the new first link correspond to one same radio. Specifically, the first link and the new first link use one same radio.

Embodiments of the present disclosure provide systems, devices and methods of wireless communications that enhances roaming performance over multiple wireless communication links or a wireless communication link. The present disclosure has the following advantages: (1) The STA MLD complies with Wi-Fi 7 specification. (2) There is no need to add any proprietary designs to the AP/AP MLD. (3) The STA/STA MLD may reduce packet loss while roaming. (4) The STA/STA MLD may shorten the handover time. (5) The MAC address collision and misordered packets reception may be avoided on the switch node. (6) The STA/STA MLD does not need Layer 3 (IP layer) rebinding in Layer 2 (MAC layer) roaming scenarios.

### Exemplary Computer Controlled System

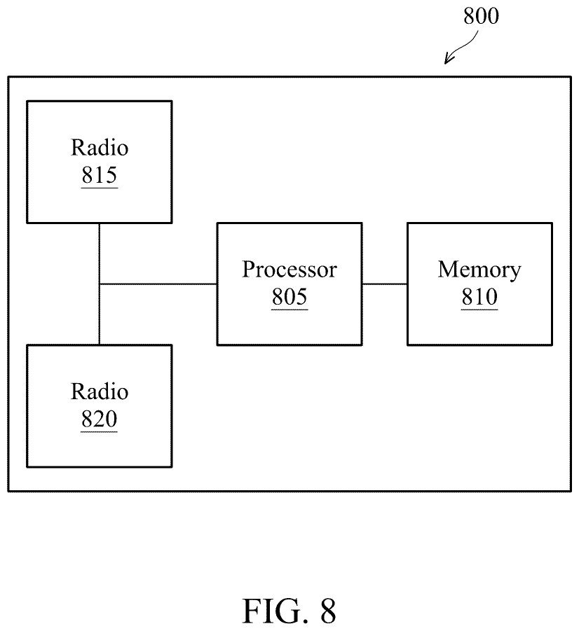

FIG. 8 depicts an exemplary wireless device 800 upon which embodiments of the present disclosure can be implemented. Embodiments of the present disclosure involve wireless devices capable of performing a method for enhancing roaming performance according to embodiments of the present disclosure.

The wireless device 800 includes a processor 805 for running software applications and optionally an operating system. A memory 810 can include read-only memory and/or random-access memory, for example, to store applications and data (e.g., tables of index values) for use by the processor 805 and data received or transmitted by radios 815 and 820. Radios 815 and 820 can communicate with other electronic devices over a wireless network (e.g., WLAN) using multiple spatial streams (e.g., multiple antennas) and typically operates according to IEEE standards (e.g., IEEE 802.11ax, IEEE 802.11ay, IEEE 802.11be, etc.). The processor can perform multi-link operations including multi-link transmissions. The wireless device 800 can including more than two radios, according to embodiments. The radio may comprise signal processing module, an antenna or amplifier et. The radio may be located inside or outside the processor. Alternatively, one part of the radio may be located inside the processor and the other part may be located outside the processor.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for enhancing roaming performance, wherein the method is implemented by a station (STA) multi-link device (MLD), and comprises:
communicating with a current AP through at least two links, wherein the at least two links comprise a first link and a second link;
disabling the second link connected to the current AP;
establishing an association with a target AP through a new second link, wherein the association comprises a new first link and the new second link;
transmitting a message to the target AP through the new second link to notify a network node that the STA is camping on a cell served by the target AP and to disable the new second link connected to the target AP;
retrieving buffered packets from the current AP through the first link for a time duration;
disconnecting from the current AP after the time duration; and
enabling the new first link and the new second link associated to the target AP to retrieve packets from the target AP,
wherein the first link and the new first link correspond to the same radio, the second link and the new second link correspond to the same radio, and the new first link and the new second link correspond to different radios.

2. The method for enhancing roaming performance as claimed in claim 1, wherein the step of disabling the second link connected to the current AP further comprises:
transmitting a QoS Null frame with PS_mode=1 to the current AP through the second link for disabling the second link connected to the current AP.

3. The method for enhancing roaming performance as claimed in claim 1, wherein the new first link is set as a power saving mode by default after the association is established.

4. The method for enhancing roaming performance as claimed in claim 3, wherein the step of enabling the new first link and the new second link associated to the target AP further comprises:
enabling the new first link by transmitting a first QOS Null frame with PS_mode=0 to the target AP through the new first link; and
enabling the new second link by transmitting a second QoS Null frame with PS_mode=0 to the target AP through the new second link.

5. The method for enhancing roaming performance as claimed in claim 1, further comprising:
stopping transmitting uplink (UL) packet of the STA MLD to the current AP through the first link after disabling the second link connected to the current AP or after establishing the association with the target AP through the new second link.

6. The method for enhancing roaming performance as claimed in claim 1, wherein the first message is transmitted after the current AP flushes buffered UL packet of the STA MLD to the network node.

7. The method for enhancing roaming performance as claimed in claim 1, wherein the message is a first broadcast message for triggering the target AP to transmit a second broadcast message to the network node to update a downlink (DL) path of the network node from the current AP to the target AP; and the first broadcast message is a QoS Null frame with PS_mode=1 for disabling the new second link connected to the target AP.

8. The method for enhancing roaming performance as claimed in claim 7, wherein the step of enabling the new first link and the new second link associated to the target AP to retrieve packets from the target AP comprises: enabling the new first link and the new second link associated to the target AP to retrieve buffered packets from the target AP, wherein the buffered packets are sent by the network node to the target AP after receiving the second broadcast message.

9. A method for enhancing roaming performance, wherein the method is implemented by a station (STA), and comprises:
communicating with a current AP through a first link;
disabling the first link connected to the current AP;
establishing an association with a target AP through a new first link;
transmitting a message to the target AP through the new first link to notify a network node that the STA is camping on a cell served by the target AP and to disable the new first link connected to the target AP;
enabling the first link to retrieve buffered packets from the current AP through the first link for a time duration;
disconnecting from the current AP after the time duration; and
enabling the new first link connected to the target AP to retrieve packets from the target AP;
wherein the first link and the new first link correspond to the same radio.

10. The method for enhancing roaming performance as claimed in claim 9, wherein the step of disabling the first link connected to the current AP further comprises:
transmitting a QoS Null frame with PS_mode=1 to the current AP through the first link for disabling the first link connected to the current AP.

11. The method for enhancing roaming performance as claimed in claim 9, further comprising:
stopping transmitting UL packets to the current AP through the first link after disabling the first link connected to the current AP.

12. The method for enhancing roaming performance as claimed in claim 9, wherein the message is a first broadcast message for triggering the target AP to transmit a second broadcast message to the network node to update a downlink (DL) path of the network node from the current AP to the target AP; and the first broadcast message is a QoS Null frame with PS_mode=1 for disabling the new first link connected to the target AP.

13. The method for enhancing roaming performance as claimed in claim 9, wherein the step of enabling the new first link associated to the target AP to retrieve packets from the target AP comprising: enabling the new first link associated to the target AP to retrieve buffered packets from the target AP, wherein the buffered packets are sent by the network node to the target AP after receiving the second broadcast message.

14. The method for enhancing roaming performance as claimed in claim 9, wherein the step of enabling the first link to retrieve packets from the current AP further comprises:
transmitting a QoS Null frame with PS_mode=1 through the first link for enabling the first link connected to the current AP.

15. A device for enhancing roaming performance, comprising:
a processor;
a plurality of radios, wherein the processor is configured to:
communicate with a current AP through at least two links, wherein the at least two links comprise a first link and a second link;
disable the second link connected to the current AP;
establish an association with a target AP through a new second link; wherein the association comprises a new first link and the new second link;
transmit a message to the target AP through the new second link to notify a network node that the STA is camping on a cell served by the target AP and to disable the new second link connected to the target AP;
retrieve buffered packets from the current AP through the first link for a time duration;
disconnect from the current AP after the time duration; and
enable the new first link and the new second link associated to the target AP to retrieve packets from the target AP;
wherein the first link and the new first link use the same radio, the second link and the new second link use the same radio, and the new first link and the new second link use different radios.

16. The device for enhancing roaming performance as claimed in claim 15, wherein disabling the second link connected to the current AP further comprises:
transmitting a QoS Null frame with PS_mode=1 to the current AP through the second link for disabling the second link connected to the current AP.

17. The device for enhancing roaming performance as claimed in claim 15, wherein the processor is further operable to:
stop transmitting uplink (UL) packet of the STA MLD to the current AP through the first link after disabling the second link connected to the current AP or after establishing the association with the target AP through the new second link.

18. The device for enhancing roaming performance as claimed in claim 15, wherein the message is a first broadcast message for triggering the target AP to transmit a second broadcast message to the network node to update a downlink (DL) path of the network node from the current AP to the target AP; and the first broadcast message is a QoS Null frame with PS_mode=1 for disabling the new second link connected to the target AP.

19. The device for enhancing roaming performance as claimed in claim 15, wherein the processor is further configured to:
transmit a first QoS Null frame with PS_mode=0 to the target AP through the new first link for enabling the new first link connected to the target AP; and
transmit a second QoS Null frame with PS_mode=0 to the target AP through the new second link for enabling the new second link connected to the target AP.

20. The device for enhancing roaming performance as claimed in claim 15, wherein the first message is transmitted after the current AP flushes buffered UL packet of the STA MLD to the network node.
